(19) United States
(12) Patent Application Publication
(10) Pub. No.: US 2008/0310146 A1
(43) Pub. Date: Dec. 18, 2008

(54) LIGHT FIXTURE HAVING MULTIPLE LIGHT SOURCES

(76) Inventor: Dennis K. Swanson, Woodland Hills, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/761,962

(22) Filed: Jun. 12, 2007

(51) Int. Cl. F21V 23/04; F21S 8/00; F21V 21/26

(52) U.S. Cl. 362/147; 362/251; 362/285; 362/295

(57) ABSTRACT

A light fixture having a general area lighting source surrounded by a shade. A plurality of task lights are supported below the general area lighting source. A divider or diffuser is disposed between the general area and task lights and serves to direct light from the general area lighting source upwardly. The fixture may be supported on a stem to function as a floor lamp; on a base to function as a table or desk lamp; on an articulated arm to function as a wall mounted lamp; or may be suspended from a ceiling to function as a ceiling mounted lamp.

### 1 FIELD OF THE INVENTION

The present invention relates generally to lighting apparatus and more particularly to a light fixture which includes both general area lighting and task lighting separated by a divider disposed therebetween which fixture may be utilized as a ceiling light, a floor lamp, a wall mounted lamp or a table lamp.

### BACKGROUND OF THE INVENTION

Electrical lighting apparatus in the form of floor lamps, table lamps, desk lamps, ceiling fixtures, wall mounted lamps and the like are well known. Such lamps generally take the form of a general area lighting device or alternatively, a task lighting device. In the recent past, stand-alone floor lamps having a combination of general lighting and task lighting on the same structure have been provided. Typical of such a structure is that disclosed in Applicant's U.S. Pat. No. 5,221,141. Such devices generally take the form of a torchiere floor lamp which has a plurality (usually two) task lights affixed at spaced apart positions upon the stem which extends between the base and an upwardly directed light reflector.

Consumers have over the past several years demanded a greater level of lighting, particularly general area lighting than was available in the past. As a result thereof, torchiere lamps were developed utilizing halogen bulbs as the light source. Such structures, however, consume a great deal of electrical energy and also it has been found that the amount of heat generated by such light sources can under certain circumstances present fire danger. As a result, halogen lamps are generally no longer available in the market place. Furthermore, efforts have been instituted to limit the amount of electrical energy consumed by light fixtures.

As a result, to provide the desired level of general area lighting, and to conserve as much energy as possible, fluorescent lighting structures have been developed which provide a substantial amount of general area lighting. These structures also take the form of a torchiere lamp having a base and a reflector disposed upwardly to direct the light from the fluorescent light bulbs upwardly. Although such structures are extremely effective and efficient, consumers in many instances, for esthetic reasons, desire a light fixture which includes a shade of a traditional type around the general area lighting means. The present invention is directed to such a structure which also includes task lighting means to provide a lighting product which will generate a substantial amount of general area lighting and at the same time provide a plurality of task lights which may be utilized for various purposes such as reading or illuminating objects of various types

### SUMMARY OF THE INVENTION

A light fixture having means for providing general area lighting with a shade surrounding the general area lighting means, means for providing task lighting, a divider or diffuser disposed between said general area and task lighting means, means for supporting the task lighting means adjacent the divider and switch means for separately controlling the general area and the task lighting means.

### BRIEF DESCRIPTION OF THE DRAWINGS

FIG. 1 is a side view of a three-light task light cluster extended from a dome canopy;

FIG. 2 is a side view of a three-light cluster of task lights extending from a flat canopy;

FIG. 3 is a side view of a three-light task light cluster supported on a spiral arm;

FIG. 4 is a side view partially in cross-section showing a single general area lighting means surrounded by a shade with a metal divider extending partially there across;

FIG. 5 is a side view partially in cross-section of a light fixture showing the combination of the general area lighting means including a plurality of bulbs and a cluster of task lights extending from a flat canopy with a divider extending across the bottom of the shade between the general area and the task lighting;

FIGS. 6, 6A, and 6B illustrate a light fixture constructed in accordance with the principles of the present invention supported upon a stem to function as a floor lamp;

FIG. 7 is a structure similar to that of FIG. 6 but having a different divider and means for supporting the task lights;

FIG. 8 is a top view taken about the lines 8-8 of FIG. 7 further illustrating the spiral arm support for the task lights; and

FIG. 9 is a side view of a swing arm lamp including a light fixture constructed in accordance with the principles of the present invention.

### DETAILED DESCRIPTION

The light fixture constructed in accordance with the principles of the present invention is adapted to have a general area lighting means preferably in the form of one or more incandescent bulbs surrounded by a shade with a plurality of task lights suspended beneath the general area lighting means. A divider or diffuser which can take various forms extends at least partially and in some cases completely across the lower end of the shade which surrounds the general area lighting means and separates the general area lighting means from the task lights. The divider or diffuser is formed in a manner preferably to direct at least some and preferably a substantial portion of the light generated by the general area lighting means in an upward direction preferably to bounce the light off of the ceiling thereby providing enhanced general area lighting surrounding the light fixture. The term divider is used throughout including the claims to mean a structure which may be opaque or translucent and may reflect or diffuse light and may extend partially or completely across the area between the general area lighting means and the task lights. The task lights may be supported in a plurality of different ways to provide a different appearance depending upon the manner in which the task lights are supported. The task lights are adapted to be suspended beneath the general area lighting means. The combination of the general area lighting means surrounded by the shade along with the task lights suspended beneath the general area lighting means and with a divider or diffuser between the general area lighting means and the task lights is adapted to be used as a ceiling fixture, affixed to a stem to function as a floor lamp, affixed to a base to function as a table lamp or supported on an arm to function as a wall mounted lamp.

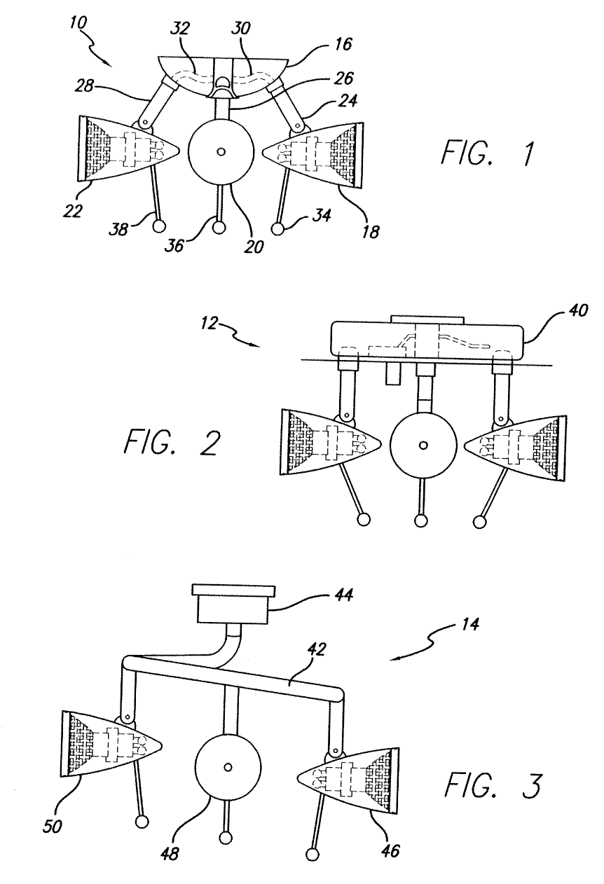

Referring now to the drawings and more particularly to FIGS. 1 through 3, there is illustrated at 10, 12, and 14, three different ways in which the task lighting of the present invention may be supported. As is shown in FIG. 1, there is provided a dome-shaped canopy 16. Three task lights 18, 20, and 22 are supported on the canopy 16 through utilization of tubular extensions 24, 26, and 28. As shown particularly at 30 and 32 electrical wiring extends through those extensions to provide electrical energy to illuminate the lights disposed within the task lights 18, 20, and 22. It will be understood by those skilled in the art that the extensions 24, 26, and 28 may include a coupling member to couple the task lights 18, 20, and 22 thereto in a manner that the task lights may be adjusted to direct them to any particular task or area that may be desired. As is also indicated, downwardly depending rods 34, 36, and 38 extend from the task lights 18, 20, and 22. These rods 34, 36, and 38 are utilized for gripping to manipulate the task lights 18, 20, and 22 to adjust them to the desired position. Without these rods an attempt to manipulate the task lights could result in discomfort to the user because of the heat generated by the lamps contained therein.

By reference to FIG. 2, the task light assembly 12 is similar in structure to that shown in FIG. 1 with the exception that a flat canopy 40 is utilized.

By reference now, more particularly to FIG. 3, there is illustrated a structure in which a downwardly spiraled arm 42 extends from a center member 44 which is adapted to be affixed to the general area lighting means or attached to a stem or base as the case may be. The spiral arm extends downwardly and is curved as shown in FIG. 3. A cluster, preferably three, of task lights 46, 48, and 50 are attached at displaced positions along the spiral arm and as above indicated, the task lights 46, 48, and 50 may be adjusted as desired for a particular task to be illuminated.

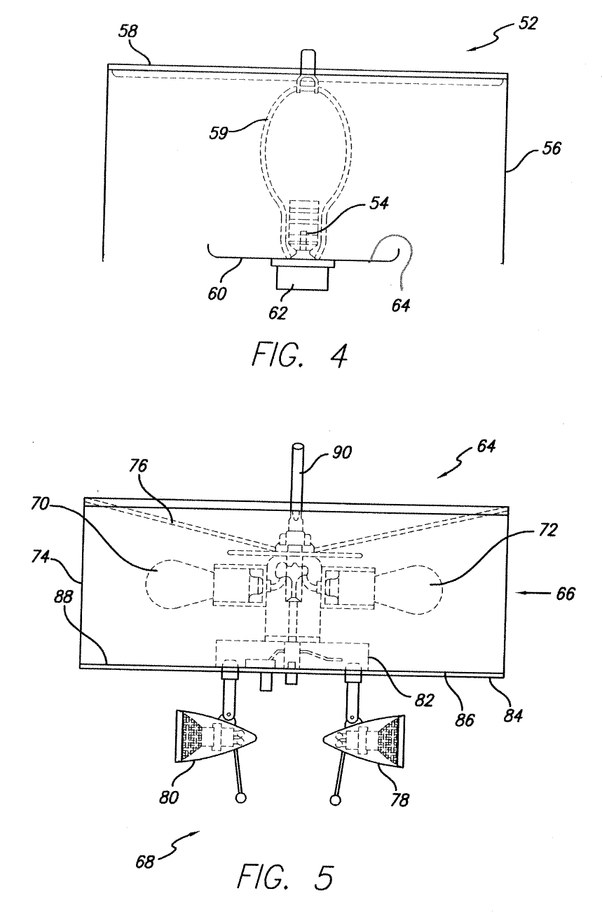

Referring now to FIG. 4, there is illustrated a general area lighting means 52 constructed in accordance with the principles of the present invention. As is therein shown, a socket 54 for receiving an incandescent light bulb is disposed within a shade 56 which in turn is supported by the usual frame 58 which in turn is supported on a harp 59. Disposed beneath the socket 54 is a divider 60 which extends partially across the bottom open end of the shade and separates the general area lighting means from the task lighting means which would be affixed to the fitting 62. Anyone of the task lighting means as illustrated in FIGS. 1, 2, and 3 could be utilized by affixing the same to the fitting 62 as may be desired. The divider 60 may be constructed of metal, plastic material or any other material desired which may reflect the general area lighting upwardly and may be either solid, opaque or translucent and it may include a reflective coating on the upwardly directed surface 64 of the divider 60.

As shown in FIG. 5, there is provided a light fixture 64 which includes a general area lighting means 66 and task lighting means 68 combined as an integral part of the light fixture 64. The light fixture 64 includes a plurality of incandescent bulbs 70, 72 and preferably includes three such bulbs disposed equa-angularly within the shade 74 which is supported upon the frame 76. Connected to the bottom portion of the general area lighting means 66 is a flat canopy such as that shown in FIG. 2 from which there is suspended a plurality of task lights as shown at 78 and 80. Preferably, three such task lights would depend from the flat canopy 82. Disclosed across the bottom of the flat canopy 82 and extending substantially across the bottom portion 84 of the shade 74 is a divider or diffuser 86. The divider 86 directs light from the bulbs 70, 72 upwardly to thereby enhance the function of the light fixture 64 in its general area lighting capability. The divider 86 may be constructed as a metallic member, the upper surface 88 of which may be a reflective material. Alternatively, the divider 86 may be constructed as a diffuser formed of a translucent plastic material such as acrylic. The light fixture 64 may also include an extension 90 or similar such structure which may be utilized to affix the light fixture 64 to the ceiling of a room thereby enabling the fixture 64 to function as a ceiling light fixture. Such an extension or fitting 90 is well known to those skilled in the art and includes attachment mechanisms for securing the light fixture 64 to a junction box or other similar structure situated within the ceiling of the room.

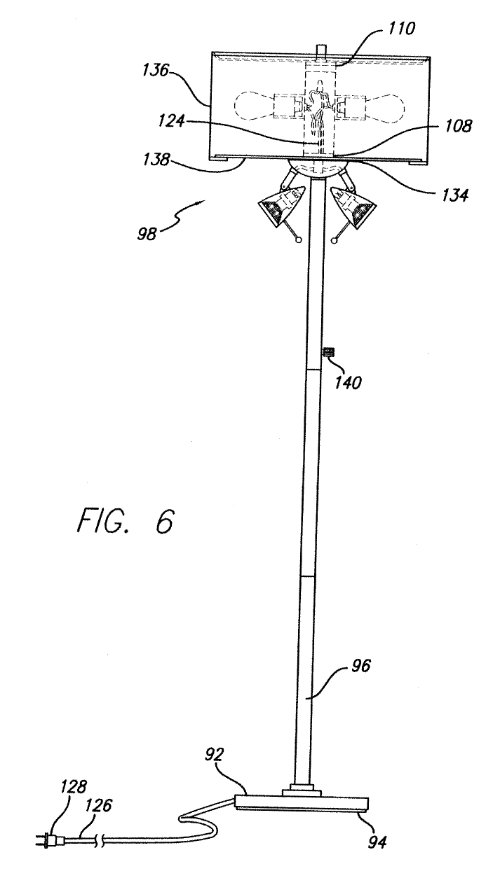

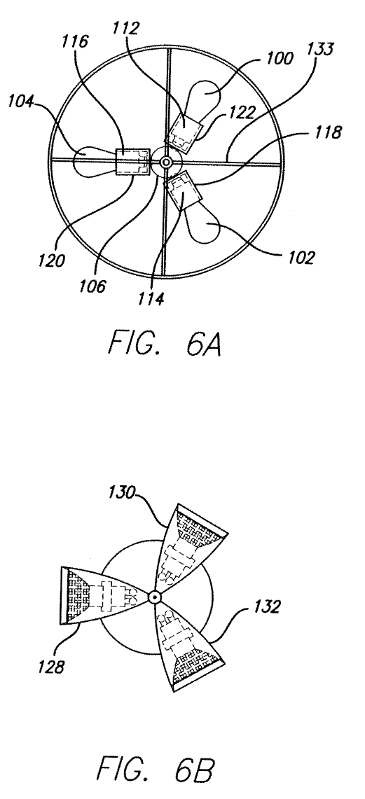

By reference now to FIG. 6, there is illustrated a light fixture constructed in accordance with the principles of the present invention which functions as a floor lamp. As is therein shown, there is a base 92 which includes a weight 94 situated in the underside thereof to stabilize the floor lamp and keep it from tilting over. Rising centrally from the base 92 is a stem 96 at the upper end of which is supported a light fixture 98 constructed in accordance with the principles of the present invention. As is therein shown, a plurality of incandescent light bulbs 100, 102, and 104 (FIG. 6A) are supported and equa-angularly disposed on a cylindrical member 106 which includes a coupler member 108 and an additional coupler member 110 disposed at each end thereof. The cylindrical member 106 is hollow and the incandescent light bulbs 100, 102 and 104 are retained within sockets 112, 114, and 116 respectively, each of which is surrounded by a metal sleeve cover 118, 120, and 122. Electrical wiring 124 is disposed internally of the cylindrical member 106 for providing electrical power to each of the bulbs 100, 102, and 104. Such power is obtained from an appropriate cord 126 which includes a plug 128 to be received within a wall receptacle or similar fitting. The cord 126 passes through the base 92 and through the hollow stem 96 upwardly to provide electrical power not only to the bulbs 100, 102, and 104 but also to the task lights 128, 130, and 132 (FIG. 6B) which are affixed to the dome canopy 134 in a manner described in conjunction with FIG. 1 above. The coupling 110 is utilized to secure a frame 133 supporting a shade 136 surrounding the incandescent bulbs 100, 102, and 104. The coupling 108 is utilized to secure a divider 138 disposed below the general area lighting including the bulbs 100, 102, and 104 and above the task lights 98. The divider 138 may be a metal member having a reflective upper surface as above described or alternatively may be a diffuser including a plastic material such as acrylic or the like which may be opaque or translucent as the application may require. A four-way rotary switch 140 is disposed on stem 96 and is utilized to control the application of electrical power to both the general area and the task light members of the light fixture.

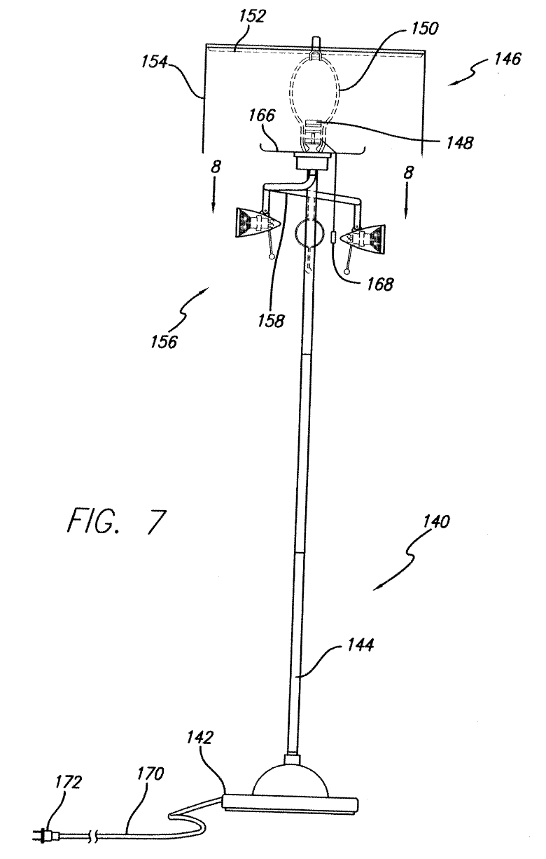

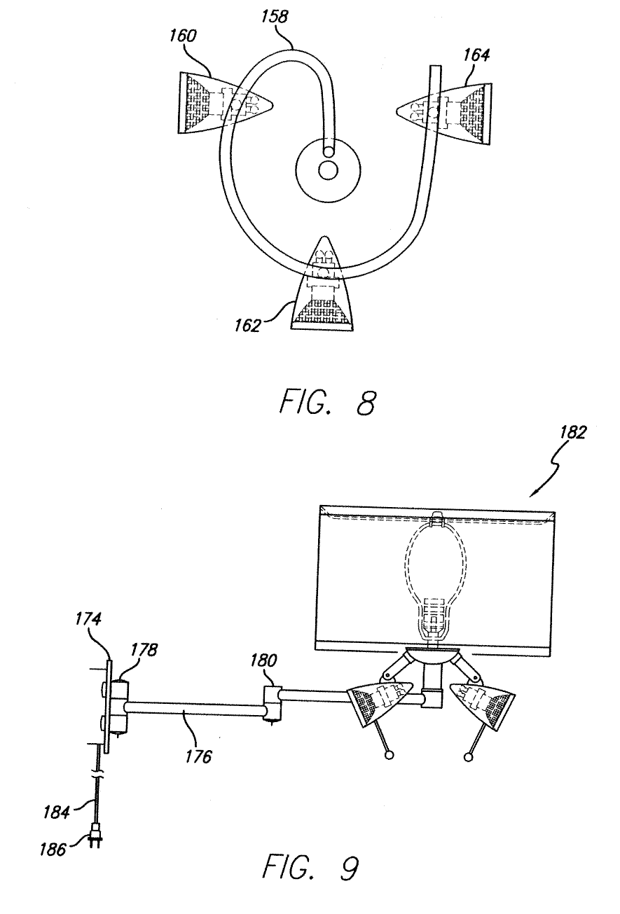

FIGS. 7 and 8 also disclose a floor lamp 140 constructed in accordance with the principles of the present invention. A floor lamp 140 includes a base 142 having a stem 144 rising centrally therefrom and extending upwardly to a general area lighting means 146. The general area lighting means includes an incandescent bulb (not shown) disposed within a socket 148. A traditional harp 150 is disposed at the top of the stem 144 and supports a frame 152 upon which a shade 154 is mounted. At the upper end of the stem 144 there is also disposed a plurality of task lights 156 supported by a spiral arm 158. As is more clearly shown in FIG. 8, the spiral arm 158 supports three task lights, 160, 162, and 164. As described above in conjunction with FIG. 1, each of the task lights may be adjusted to illuminate the particular object desired. A divider 166 is disposed between the general area lighting means 146 and the task lights 156 and functions in the manner as above described to enhance the function of the general area lighting means. A pull chain 168 is utilized to provide electrical energy to the bulb (not shown) secured in the socket 148. Such electrical energy is provided by a cord 170 which has a plug 172 for insertion into a wall socket or the like.

A light fixture constructed in accordance with the principles of the present invention may also be utilized as a wall mounted lamp as shown in FIG. 9. As is therein illustrated, there is provided a fixture 174 for attachment to a wall (not shown). Extending from the fixture 174 is an articulated arm 176 which is mounted at a pivot 178 and is pivoted at 180 to enable positioning of the light fixture 182 to any position desired. A light fixture 182 includes the general area lighting means similar to that described in conjunction with FIG. 7. At the lower end of the general area lighting means there is secured a dome canopy having a plurality of task lights mounted thereon similar to that described above in conjunction with FIG. 1. Electrical energy is provided to energize the general area light, as well as the task lights by a cord 184 which includes a plug 186 for insertion into a wall receptacle or the like.

There has thus been described a light fixture which provides both a general area lighting means having a shade surrounding the same, as well as means for providing task lighting. A divider or diffuser is disposed between the general area and the task lighting means which functions to enhance the ability of the general area lighting means, the light fixture may be utilized as a ceiling light, floor lamp, table lamp or a wall mounted lamp as the case may be.

What is claimed is:

1. A light fixture comprising:
means for providing general area lighting;
a shade surrounding said general area lighting means and having a top and bottom rim;
means for providing task lighting;
a divider disposed between said general area and task lighting means;
means for supporting said task lighting means adjacent said divider; and
switch means for separately controlling said general area and said task lighting means.

2. A light fixture as defined in claim 1, which further includes a downwardly spiraling rod disposed below said divider, said means for providing task lighting including a plurality of task lights supported by said rod.

3. A light fixture as defined in claim 2, wherein said switch means includes a separate switch for controlling each of said plurality of task lights.

4. A light fixture as defined in claim 1, wherein said means for providing task lighting includes a plurality of task lights supported by said divider.

5. A light fixture as defined in claim 1, wherein said divider directs illumination from said general area lighting upwardly.

6. A light fixture as defined in claim 5, wherein said divider extends substantially across said bottom rim of said shade.

7. A light fixture as defined in claim 5, wherein said divider is opaque.

8. A light fixture as defined in claim 5, wherein said divider is translucent.

9. A light fixture as defined in claim 1, further including means for affixing said light fixture to a ceiling.

10. A light fixture as defined in claim 1, further including means for affixing said light fixture to an upstanding stem to provide a floor lamp.

11. A light fixture as defined in claim 1, further including means for affixing said light fixture to a base to provide a table lamp.

12. A light fixture as defined in claim 1, further including means for affixing said light fixture to an arm for providing a swing arm wall mounted lamp.

13. A light fixture as defined in claim 6, which further includes a downwardly spiraling rod disposed below said divider, said means for providing task lighting including a plurality of task lights supported by said rod.

14. A light fixture as defined in claim 13, wherein said switch means includes a separate switch for controlling each of said plurality of task lights.

15. A light fixture as defined in claim 6, wherein said means for providing task lighting includes a plurality of task lights supported by said divider.

16. A light fixture as defined in claim 15, wherein said switch means includes a separate switch for controlling each of said plurality of task lights.
